(19) United States
(12) Patent Application Publication
(10) Pub. No.: US 2023/0129221 A1
(43) Pub. Date: Apr. 27, 2023

(54) OXYGEN SUPPLEMENTATION SYSTEM FOR SUPPORTING COMBUSTION ENGINES IN OXYGEN DIMINISHED ENVIRONMENTS

(71) Applicant: PyroNemesis, Inc., Boulder, CO (US)

(72) Inventor: Stephen WOLF, Boulder, CO (US)

(21) Appl. No.: 18/048,174

(22) Filed: Oct. 20, 2022

Related U.S. Application Data
(60) Provisional application No. 63/270,268, filed on Oct. 21, 2021.

(51) Int. Cl. F02D 21/02; F02M 25/10

(52) U.S. Cl. CPC F02D 21/02; F02M 25/10

(57) ABSTRACT

Described are oxygen enrichment systems that allow combustion powered vehicles to operate in reduced oxygen environments.

This application claims the benefit of U.S. Provisional Application No. 63/270,268, filed Oct. 21, 2021, which is hereby incorporated by reference in its entirety herein.

### BACKGROUND

Climate conditions increasingly favor the development of catastrophic wildfires of previously unseen magnitude. The need to dispatch emergency response vehicles, including police, ambulance and fire trucks into these hazardous environments, is growing. An unexpected danger of responding to these emergencies is that the combustion engines that power emergency vehicles are not designed to run in these oxygen depleted environments, and frequently fail, leaving crews and their vehicles vulnerable to advancing fires.

### SUMMARY

One aspect provided herein is an oxygen supplementation system for a combustion engine powered vehicle, the system comprising: an oxygen source coupled to the vehicle; a regulator fluidically coupled to the oxygen source; a flow meter fluidically coupled to the regulator and an intake of the vehicle; an ambient air sensor measuring at least an oxygen content of air outside the vehicle; and a control unit comprising a non-transitory computer-readable storage media encoded with a computer program including instructions executable by a processor to create an application comprising: a flow module receiving a flow rate from the flow meter; an ambient module receiving the oxygen content; and a regulating module controlling an output pressure of the regulator based on the flow rate, the oxygen content, or both.

In some embodiments, the system further comprises a communication device communicably coupled to the control unit. In some embodiments, the communication device receives a desired flow rate, a local oxygen content, or both, and wherein the regulating module further controls the output pressure of the regulator based on the desired flow rate, the local oxygen content, or both. In some embodiments, the system further comprises a control panel, wherein the regulating module further controls the output pressure of the regulator based on a user instruction received from the control panel. In some embodiments, the application further comprises a display module transmitting the flow rate, the oxygen content, or both, to be displayed by the control panel. In some embodiments, the control panel is communicatively coupled to the communications device. In some embodiments, the system further comprises a filter in fluidic communication with the oxygen source, the regulator fluidically, the flow meter or any combination thereof.

Another aspect provided herein is a computer-implemented method of supplementing oxygen to a combustion engine powered vehicle, the method comprising: receiving, by a computer, a flow rate of oxygen exiting an oxygen source from an oxygen meter; receiving, by the computer, an ambient oxygen content; and controlling, by the computer, an output pressure of a regulator based on the flow rate, the oxygen content, or both; wherein the regulator is fluidically coupled to the oxygen meter, the oxygen source, and an intake of the vehicle.

In some embodiments, the method further comprises receiving, by the computer: a desired flow rate; a local oxygen content; a user instruction; or any combination thereof wherein the output pressure of the regulator is further controlled based on the desired flow rate, the local oxygen content, the user instruction, or any combination thereof. In some embodiments, the method further comprises, by the computer, the flow rate, the oxygen content, or both, to be displayed by a control panel. In some embodiments, the computer increases an output pressure of the regulator if the oxygen content is below about 20%.

Another aspect provided herein is a non-transitory computer-readable storage media encoded with a computer program including instructions executable by a processor to create an application comprising: a flow module receiving a flow rate from a flow meter; an ambient module receiving any oxygen content from an ambient air sensor; and a regulating module controlling an output pressure of a regulator based on the flow rate, the oxygen content, or both.

In some embodiments, the application further comprises receiving, by a communication module: a desired flow rate; a local oxygen content; a user instruction; or any combination thereof; wherein the regulating module further controls the output pressure of the regulator based on the desired flow rate, the local oxygen content, the user instruction, or any combination thereof. In some embodiments, the application further transmitting, by the computer, the flow rate, the oxygen content, or both, to be displayed by a control panel. In some embodiments, the regulating module increases an output pressure of the regulator if the oxygen content is below about 20%.

Another aspect provided herein is an oxygen supplementation system that allows combustion engine powered vehicles to operate in diminished fuel environments, consisting of: an oxygen source fluidically coupled to a regulator; that regulator, fluidically coupled to the air intake port of a combustion engine; a sensor to determine the oxygen concentration of the ambient air; a sensor to determine the oxygen concentration or the oxygen enriched air; a computerized control unit to monitor the sensors and adjust the flow of oxygen from the regulator; electrical wiring as needed to connect the components that pass data; and/or wireless components to pass data between components fluidic connectors as needed to provide the flow of confined and directed gases; a display panel displaying system status and other key data to the user a communications /telemetry system to share this data to remote parties.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an illustration of an exemplary oxygen supplementation system for a combustion engine vehicle; and

FIG. 2 shows a diagram of an exemplary oxygen supplementation system for a combustion engine vehicle.

### DETAILED DESCRIPTION

The combustion engines common in emergency vehicles operate by burning fuel with air comprising about 20% oxygen. When conditions such as wildfires diminish ambient oxygen levels, these vehicles fail, often with catastrophic results.

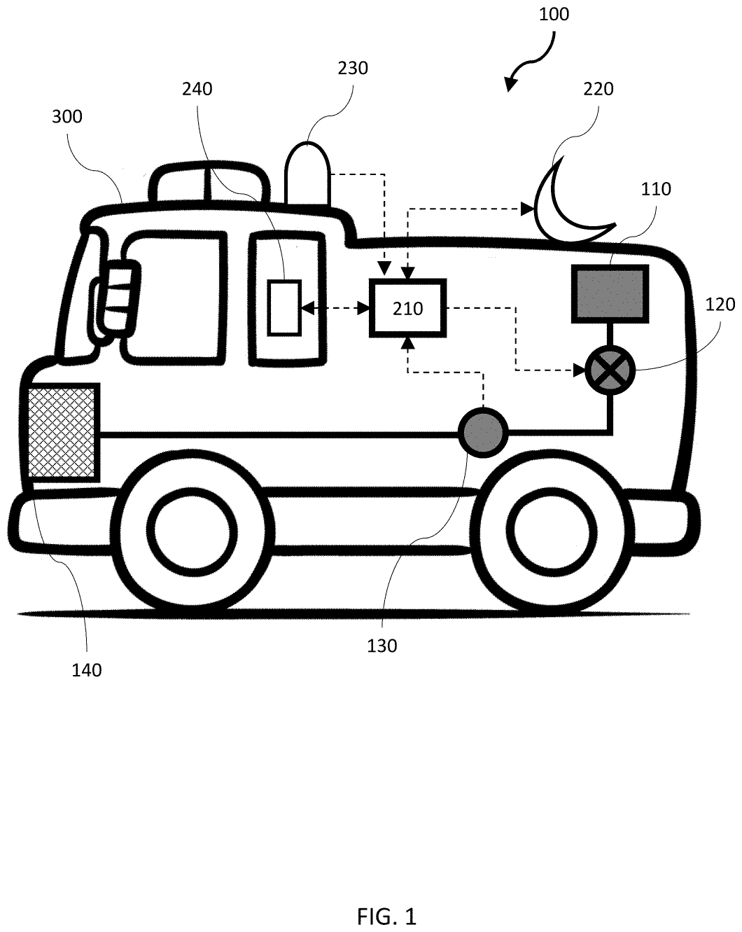

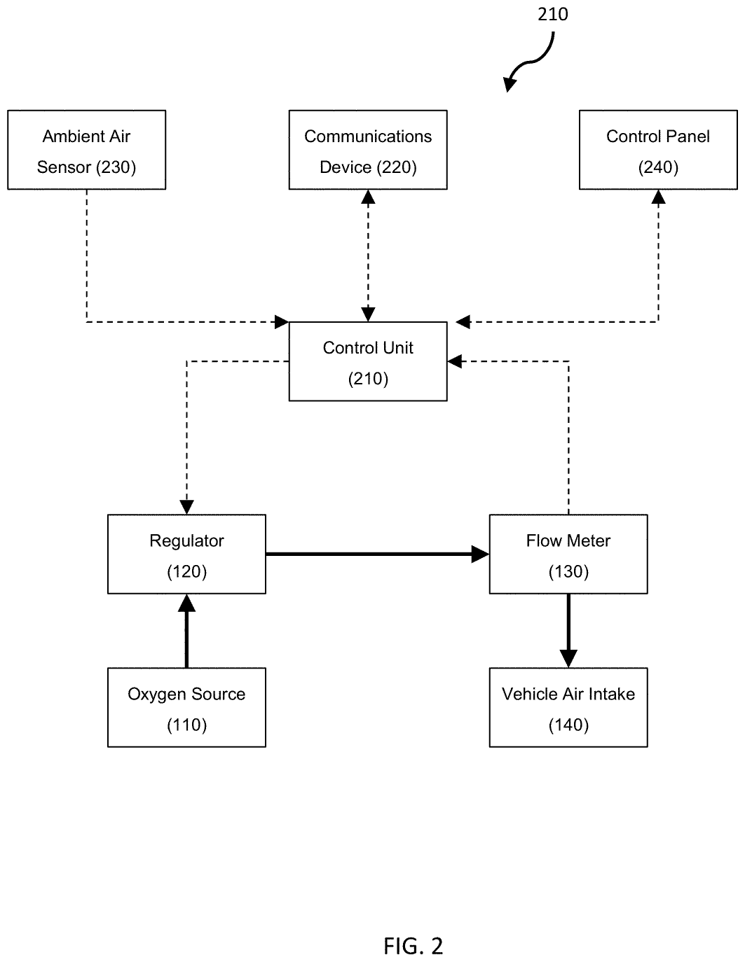

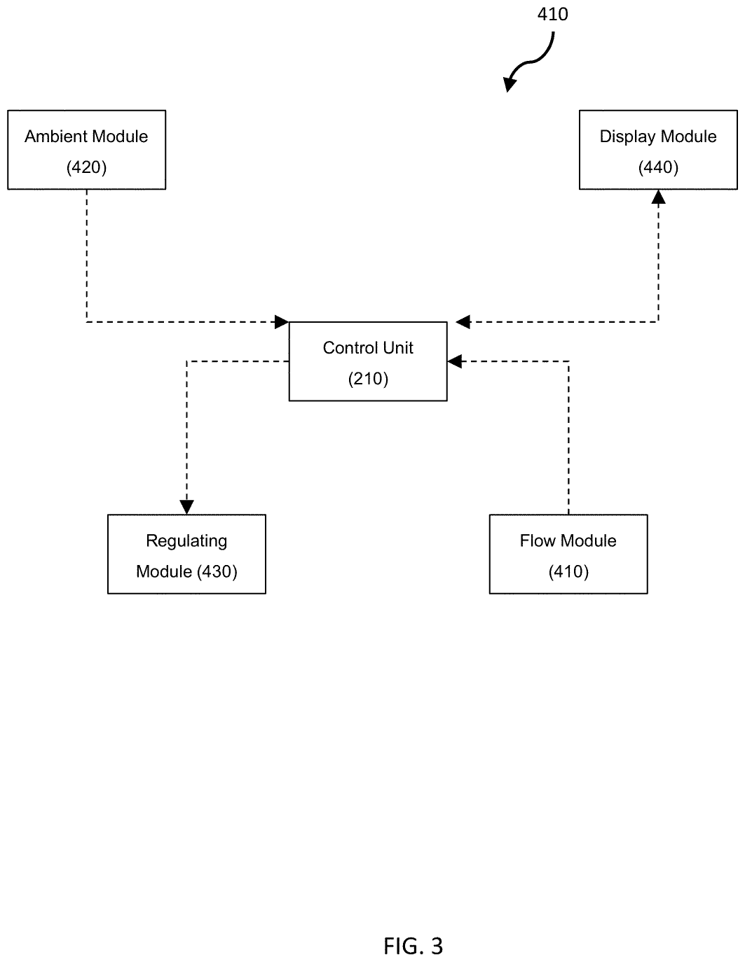

One aspect provided herein, per FIGS. 1-3, is an oxygen supplementation system 100 for a combustion engine powered vehicle 300. In some embodiments, the system 100 comprises an oxygen source 110, a regulator 120, a flow meter 130, an ambient air sensor 230, and a control unit 210.

In some embodiments, the oxygen source 110 is coupled to the vehicle 300. The regulator 120 may be fluidically coupled to the oxygen source 110. The flow meter 130 fluidically may be coupled to the regulator 120 and an intake 140 of the vehicle 300. The ambient air sensor 230 may measure at least an oxygen content of air outside the vehicle 300.

The control unit 210 may comprise a non-transitory computer-readable storage media encoded with a computer program including instructions executable by a processor to create an application. In some embodiments, the application comprises a flow module, an ambient module 420, and a regulating module 410. In some embodiments, the flow module receives a flow rate from the flow meter 130. The ambient module 420 may receive the oxygen content, wherein the regulating module 410 may control an output pressure of the regulator 120 based on the flow rate, the oxygen content, or both.

In some embodiments, the system 100 further comprises a communication device 220 communicably coupled to the control unit 210. The communication device 220 may receive a desired flow rate, a local oxygen content, or both, wherein the regulating module 410 may further control the output pressure of the regulator 120 based on the desired flow rate, the local oxygen content, or both. In some embodiments, the system 100 further comprises a control panel, wherein the regulating module 410 may further control the output pressure of the regulator 120 based on a user instruction received from the control panel. In some embodiments, the application further comprises a display module 440 transmitting the flow rate, the oxygen content, or both, to be displayed on a display 240 by the control panel. The control panel may be communicatively coupled to the communications device. The system 100 may further comprise a filter in fluidic communication with the oxygen source 110, the regulator 120 fluidically, the flow meter 130 or any combination thereof.

Another aspect provided herein is a computer-implemented method of supplementing oxygen to a combustion engine powered vehicle 300, the method comprising: receiving, by a computer, a flow rate of oxygen exiting an oxygen source 110 from an oxygen meter; receiving, by the computer, an ambient oxygen content; and controlling, by the computer, an output pressure of a regulator 120 based on the flow rate, the oxygen content, or both; wherein the regulator 120 is fluidically coupled to the oxygen meter, the oxygen source 110, and an intake of the vehicle 300.

In some embodiments, the method further comprises receiving, by the computer: a desired flow rate; a local oxygen content; a user instruction; or any combination thereof wherein the output pressure of the regulator is further controlled based on the desired flow rate, the local oxygen content, the user instruction, or any combination thereof. In some embodiments, the method further comprises, by the computer, the flow rate, the oxygen content, or both, to be displayed by a control panel. In some embodiments, the computer increases an output pressure of the regulator if the oxygen content is below about 20%.

Another aspect provided herein is a non-transitory computer-readable storage media encoded with a computer program including instructions executable by a processor to create an application comprising: a flow module receiving a flow rate from a flow meter; an ambient module receiving any oxygen content from an ambient air sensor; and a regulating module controlling an output pressure of a regulator based on the flow rate, the oxygen content, or both.

In some embodiments, the application further comprises receiving, by a communication module: a desired flow rate; a local oxygen content; a user instruction; or any combination thereof; wherein the regulating module further controls the output pressure of the regulator based on the desired flow rate, the local oxygen content, the user instruction, or any combination thereof. In some embodiments, the application further transmitting, by the computer, the flow rate, the oxygen content, or both, to be displayed by a control panel. In some embodiments, the regulating module increases an output pressure of the regulator if the oxygen content is below about 20%.

Another aspect provided herein is an oxygen supplementation system, comprising: an oxygen sensor mounted in or on the vehicle to monitor ambient oxygen concentration; a computer to analyze data from the sensor, an oxygen source, such as a cylinder containing compressed oxygen (or other gases from which oxygen may be derived during combustion, such as nitrous oxide), a regulator, controlled by the computer, to control the flow of oxygen from the oxygen source, and a delivery system of pipes, hoses or other means of fluidically coupling oxygen to the air intake port of the combustion engine.

In some embodiments, the system further comprises an additional sensor to ensure that the ambient air has been enriched to about 21% oxygen. In some embodiments, the system further comprises filters (mechanical, electrostatic, centrifugal, or otherwise) to reduce the introduction of particulate matter in the engine's air intake. In some embodiments, the system calculates, based on the oxygen consumption rate, the remaining time that the on-board oxygen will last. In some embodiments, the system may incorporate the use of oxygen-concentrators as a sole or an additional source of oxygen. In some embodiments, the system further comprises a manifold to allow the simultaneous use of multiple sources of oxygen, such as a plurality of oxygen tanks, or a combination of oxygen tanks and oxygen concentrators. In some embodiments, the system may be permanently installed in the host vehicle. In some embodiments, the system may consist of portable components that may be quickly and easily installed by a person of limited engineering skill. In some embodiments, the system may include telemetry of system performance and status to remote parties. In some embodiments the system may be connected, via a vehicle's OBD port or similar point of access, to the vehicle's onboard computer, where it may both share data with and from the vehicle, and access sensors on the vehicle. In some embodiments, the system may be incorporated into other terrestrial vehicles, into marine and submarine craft, into aircraft, and spacecraft.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “air” refers to the ambient gases around and near a vehicle, even if the gases present are not the typical mixture of 78 percent nitrogen, 21 percent oxygen, and small amounts of other gases. As used herein, “air” may include carbon monoxide, carbon dioxide, products of combustion, products present as a result of hazardous material leaks, or any other combination of gases that may be present proximal to an emergency vehicle.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. An oxygen supplementation system for a combustion engine powered vehicle, the system comprising:
(a) an oxygen source coupled to the vehicle;
(b) a regulator fluidically coupled to the oxygen source;
(c) a flow meter fluidically coupled to the regulator and an intake of the vehicle;
(d) an ambient air sensor measuring at least an oxygen content of air outside the vehicle; and
(e) a control unit comprising a non-transitory computer-readable storage media encoded with a computer program including instructions executable by a processor to create an application comprising:
(i) a flow module receiving a flow rate from the flow meter;
(ii) an ambient module receiving the oxygen content; and
(iii) a regulating module controlling an output pressure of the regulator based on the flow rate, the oxygen content, or both.

2. The system of claim 1, further comprising a communication device communicably coupled to the control unit.

3. The system of claim 2, wherein the communication device receives a desired flow rate, a local oxygen content, or both, and wherein the regulating module further controls the output pressure of the regulator based on the desired flow rate, the local oxygen content, or both.

4. The system of claim 1, further comprising a control panel, wherein the regulating module further controls the output pressure of the regulator based on a user instruction received from the control panel.

5. The system of claim 4, wherein the application further comprises a display module transmitting the flow rate, the oxygen content, or both, to be displayed by the control panel.

6. The system of claim 4, wherein the control panel is communicatively coupled to the communications device.

7. The system of claim 1, wherein the regulating module increases an output pressure of the regulator if the oxygen content is below about 20%.

8. The system of claim 1, further comprising a filter in fluidic communication with the oxygen source, the regulator fluidically, the flow meter or any combination thereof.

9. A computer-implemented method of supplementing oxygen to a combustion engine powered vehicle, the method comprising:
(a) receiving, by a computer, a flow rate of oxygen exiting an oxygen source from an oxygen meter;
(b) receiving, by the computer, an ambient oxygen content; and
(c) controlling, by the computer, an output pressure of a regulator based on the flow rate, the oxygen content, or both;
wherein the regulator is fluidically coupled to the oxygen meter, the oxygen source, and an intake of the vehicle.

10. The method of claim 8, further comprising receiving, by the computer:
(a) a desired flow rate;
(b) a local oxygen content;
(c) a user instruction; or
(d) any combination thereof;
(e) wherein the output pressure of the regulator is further controlled based on the desired flow rate, the local oxygen content, the user instruction, or any combination thereof.

11. The method of claim 8, further comprising, transmitting, by the computer, the flow rate, the oxygen content, or both, to be displayed by a control panel.

12. The method of claim 8, wherein the computer increases an output pressure of the regulator if the oxygen content is below about 20%.

13. A non-transitory computer-readable storage media encoded with a computer program including instructions executable by a processor to create an application comprising:
(a) a flow module receiving a flow rate from a flow meter;
(b) an ambient module receiving any oxygen content from an ambient air sensor; and
(c) a regulating module controlling an output pressure of a regulator based on the flow rate, the oxygen content, or both.

14. The media of claim 12, wherein the application further comprises receiving, by a communication module:
(a) a desired flow rate;
(b) a local oxygen content;
(c) a user instruction; or
(d) any combination thereof
wherein the regulating module further controls the output pressure of the regulator based on the desired flow rate, the local oxygen content, the user instruction, or any combination thereof.

15. The media of claim 12, wherein the application further comprises, transmitting, by the computer, the flow rate, the oxygen content, or both, to be displayed by a control panel.

16. The media of claim 12, wherein the regulating module increases an output pressure of the regulator if the oxygen content is below about 20%.
